(19) United States
(12) Patent Application Publication
(10) Pub. No.: US 2006/0221389 A1
(43) Pub. Date: Oct. 5, 2006

(54) Image output device, image output method and image output program

(75) Inventor: Masaharu Meki, Akishima-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/375,280

(22) Filed: Mar. 14, 2006

(30) Foreign Application Priority Data
Mar. 15, 2005 (JP) 2005-073104

(51) Int. Cl. G06F 3/12

(52) U.S. Cl. 358/1.15; 358/462

(57) ABSTRACT

An image output device comprises an image reading unit which reads an image which includes an instruction image, an instruction data analysis unit which analyzes instruction data included in image data read by the image reading unit, a search unit which searches an information resource storage unit in which information resources are stored for an information resource specified by the instruction data, a determination unit which compares the image data read by the image reading unit with a searched information resource searched by the search unit to determine whether or not the read image and the searched information resource are identical, and an image printing unit which prints the searched information resource when the determination unit determines that the read image and the searched information resource are not identical.

### CROSS-REFERENCE TO RELATED APPLICATIONS

This application is based upon and claims the benefit of priority from prior Japanese Patent Application No. 2005-073104, filed Mar. 15, 2005, the entire contents of which are incorporated herein by reference.

### BACKGROUND OF THE INVENTION

1. Field of the Invention

The present invention relates to an image output device comprising an image reading unit for reading original images and an image printing unit for printing and outputting images; an image output method; and an image output program.

2. Description of the Related Art

Conventionally, in response to a copying instruction from an operator, an image output device such as a copying machine, reads original images of an object to be read that is placed on an original base plate, and records the read image data on a recording medium such as paper.

In addition, in a prior composite machine equipped with a plurality of functions such as FAX (facsimile) function, copying function, file handling function, etc., code information including a type of processing and a document number indicated in the mark column on a document image is identified and a predetermined composite image processing such as copying function is performed.

However, a prior composite machine has a problem that separate operations of storing document images and specifying a stored file are needed, because document images read in advance by the composite machine are copied and output by specifying the stored file after they are stored in an external storage device of the composite machine.

The prior art has another problem that since document images read in advance by the composite machine can only be copied and output to a file stored in the external storage device, any document image whose content may often change must be stored every time a change is made, which thus makes the storing operation cumbersome.

The prior art has still another problem that a predetermined sheet other than an original paper is needed to specify a file to copy.

### BRIEF SUMMARY OF THE INVENTION

The present invention has been made in light of the above condition, and an object of the invention is to provide an image output device, an image output method and an image output program that enable an original paper of copying to be automatically rewritten to up-to-date state, and copied and output with simple specification and simple operation.

Another object of the present invention is to provide an image output device, an image output method and an image output program that enable only an authorized person to automatically rewrite an original paper of copying to up-to-date state, and copy and output it with simple specification and simple operation.

According to one aspect of the invention, an image output device comprises:

an image reading unit which reads an image which includes an instruction image;

an instruction data analysis unit which analyzes instruction data included in image data read by the image reading unit;

a search unit which searches an information resource storage unit in which information resources are stored for an information resource specified by the instruction data;

a determination unit which compares the image data read by the image reading unit with a searched information resource searched by the search unit to determine whether or not the read image and the searched information resource are identical; and

an image printing unit which prints the searched information resource when the determination unit determines that the read image and the searched information resource are not identical.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a system diagram of a copying system according to a first embodiment of the invention;

FIG. 2 is a functional block diagram of a copying unit in the copying system of FIG. 1;

FIG. 3 is a block diagram illustrating a hardware configuration of the copying unit in the copying system of FIG. 1;

FIG. 4 is a system diagram of a copying system according to a second embodiment of the invention;

FIG. 5 is a system diagram of a copying system according to a third embodiment of the invention;

FIG. 6 is a flow chart showing a flow of an image output process to be executed in the copying system according to the embodiments of the present invention;

FIG. 7 is a flow chart showing a flow of a “file data search process” shown in FIG. 6;

FIG. 8 is a flow chart showing a flow of a “Web data search process” shown in FIG. 6;

FIG. 9 is a view illustrating a printout example 1 of file data;

FIG. 10 is a view illustrating a printout example 2 of file data;

FIG. 11 is a view illustrating a printout example 3 of file data;

FIG. 12 is a view illustrating a printout example 4 of file data;

FIG. 13 is a view illustrating a printout example of Web data; and

FIG. 14 is a view illustrating a facsimile output example of Web data.

### DETAILED DESCRIPTION OF THE INVENTION

An embodiment of an image output device, an image output method, and an image output program according to the present invention will now be described with reference to the accompanying drawings.

The outline of the embodiment is as follows. Copy source data is described in a specific format in advance in an original paper of copying, and if the copy source data has been updated when the original paper is copied, the copy source data is automatically searched and the latest data is copied and output together with the last update date, and if the copy source data has not been updated, the copy source data is directly copied and output.

The copy source data may be data of Web specified by URL or file data specified by a file name.

When copy source data is searched, user authentication of an operator who copies can be executed. In addition, when copy source data is searched, charging may also take place.

A paper size or output format of printout can also be specified, and a description format of copy source data may be a two-dimensional code. Furthermore, facsimile output may substitute for printout.

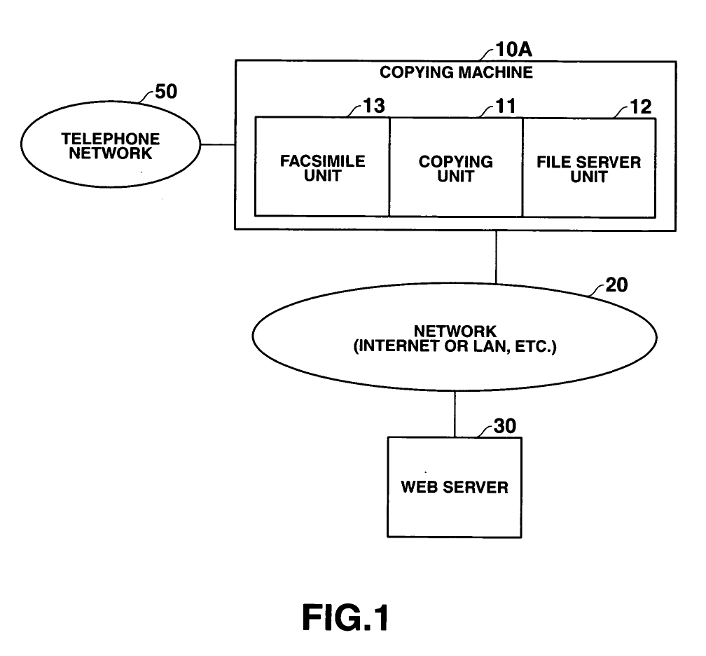

FIG. 1 is a system configuration diagram of a copying machine according to a first embodiment of the invention. A copying machine 10A is connected to a telephone network 50. The copying machine 10A is further connected to a Web server 30 via a network 20 such as the Internet, LAN (Local Area Network), VPN (Virtual Private Network), etc. and prints and outputs Web data by an image printing unit provided in the copying unit 11. The copying machine 10A includes a copying unit 11, a file server unit 12, and a facsimile unit 13. The file server unit 12 stores file data created by various application software programs. The copying unit 11 prints and outputs the file data by the image printing unit provided in the copying unit 11.

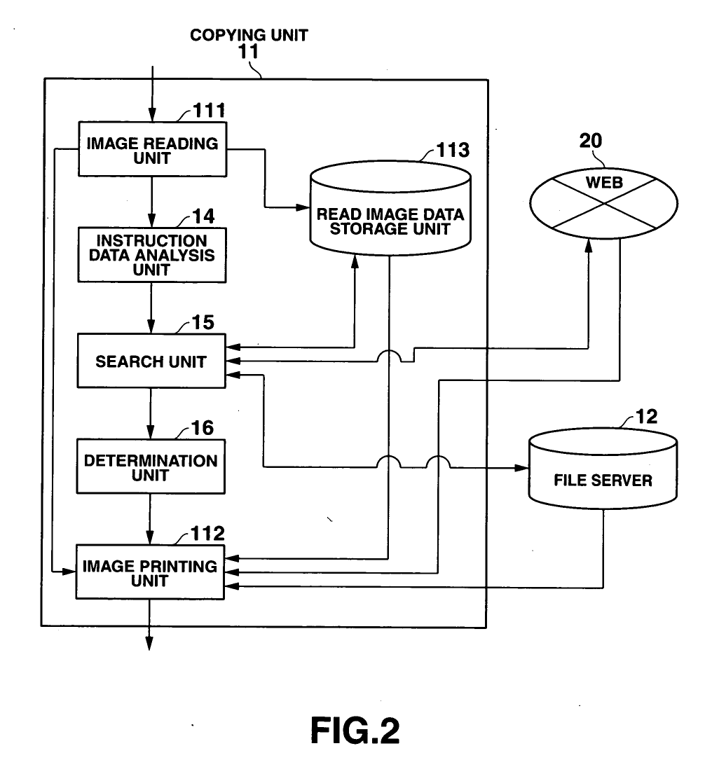

FIG. 2 is a functional block diagram of the copying unit 11 shown in FIG. 1.

The copying unit 11 comprises an image reading unit 111 for reading an original image, a read image data storage unit 113 for storing image data read by the image reading unit 111, and an image printing unit 112 for printing and outputting the image data read by the image reading unit 111 directly or the image data once stored in the read data storage unit 113 after reading them, which are provided in a conventional digital copier. In addition, the copying unit 11 comprises instruction data analysis unit 14, search unit 15, and determination unit 16.

The instruction data analysis unit 14 analyzes instruction data included in the image data read by the image reading unit 111.

Based on the instruction data analyzed by the instruction data analysis unit 14, the search unit 15 searches an information resource storage unit such as the read image data storage unit 113, home pages on the Internet (network 20), the file server unit 12, etc. in which information resources such as image data, Web data, file data, etc. are stored for an information resource specified by the instruction data.

The determination unit 16 compares the image data read by the image reading unit 111 with the information resource searched by the search unit 15 and determines whether or not they are identical.

A method of determining identity to be executed by the determination unit 16 makes a determination, for instance, with whether or not date information included in a predetermined position of the image data is same as date information included in the information resource.

If the determination unit 16 determines that there is no identity, the image printing unit 112 prints and outputs the information resource searched by the search unit 15. On the other hand, if the determination unit 16 determines that there is identity, the image printing unit 112 prints and outputs the image data read by the image reading unit 111.

The instruction data included in the read image data is, for instance, URL (Uniform Resource Locator) indicating a storage location of the information resource stored on the Internet (network 20), and the information resource in this case is World Wide Web (WWW) data.

In another example, the instruction data included in the read image data is a file address indicating a storage location of the information resource stored in a storage medium such as the file server unit 12, and the information resource in this case is file data created by various application software programs.

In addition to the URL and file address described above, the instruction data may include a two-dimensional code.

The instruction data can also include format information for specifying an output format of the image printing unit 112.

The copying machine 10A may comprise an authentication unit for authenticating an operator. Therefore, the image printing unit 112 prints and outputs the information resource searched by the search unit 115 or the image data read by the image reading unit 111 only if the authentication unit authenticates that the operator is an predetermined operator.

The copying machine 10A may comprise a charging unit. Therefore, the content which is searched for by the search unit 15 can be charged.

Since the copying machine 10A includes the facsimile unit 13 for transmitting image data by facsimile, the copying machine 10A can transmit read image data, Web data or file data to a remote location through the telephone network 50 if the instruction data included in the read image data includes an output instruction to send by facsimile, instead of printout.

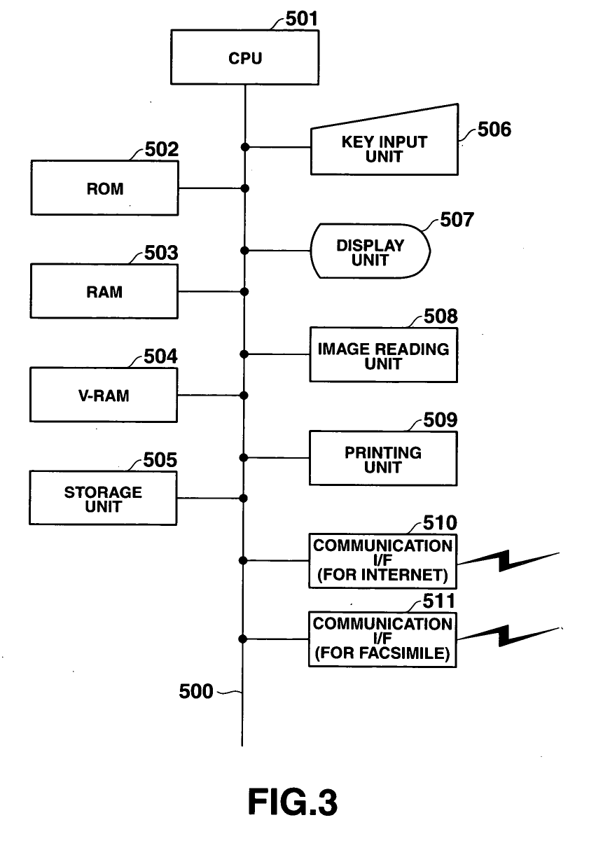

FIG. 3 is a diagram illustrating a hardware configuration of the copying unit 11 of FIG. 1.

The copying unit 11 includes a CPU 501 connected to a bus 500, memories such as a ROM 502, a RAM 503, a V-RAM 504, etc., a storage unit 505, a key input unit 506, a display unit 507, an image reading unit 508, a printing unit 509, a communication interface (I/F) (for the Internet) 510, and a communication interface (for facsimile) 511.

Control programs for controlling and executing the respective functions of the copying unit 11 are stored in the ROM 502. In the storage unit 505, not only information such as an ID or password for user authentication is stored in advance in a predetermined format, but also various programs, etc. for reading files are contained.

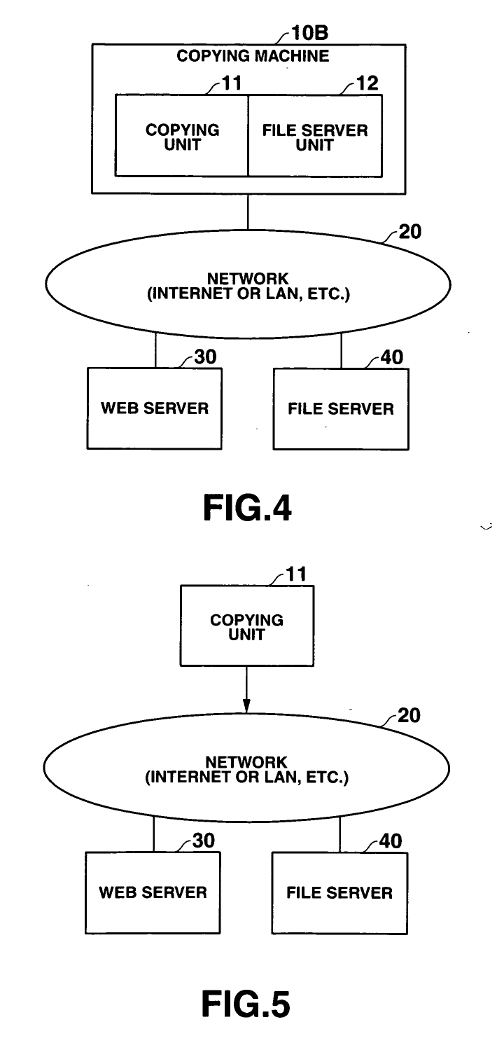

FIG. 4 is a system configuration diagram of a copying machine according to a second embodiment of the invention.

A copying machine 10B comprises the copying unit 11 and file server unit 12, but does not include the facsimile unit 13. Similar to the copying system according to the first embodiment described with reference to FIG. 2, the copying machine 10B is connected to the Web server 30 on the Internet by way of the network 20, and prints and outputs Web data by the image printing unit 112 provided in the copying unit 11. The copying machine 10B is also connected, by way of the network 20, to a file server 40 for storing file data created by various application software, and prints and outputs the file data by the image printing unit 112 provided in the copying unit 11.

FIG. 5 is a system configuration diagram of a copying machine according to a third embodiment of the invention. The copying machine of the third embodiment comprises the copying unit 11, but does not comprise the file server unit 12 and the facsimile unit 13.

In the following, explanation will be given for a flow of image output process to be executed at the copying machine according to the embodiments.

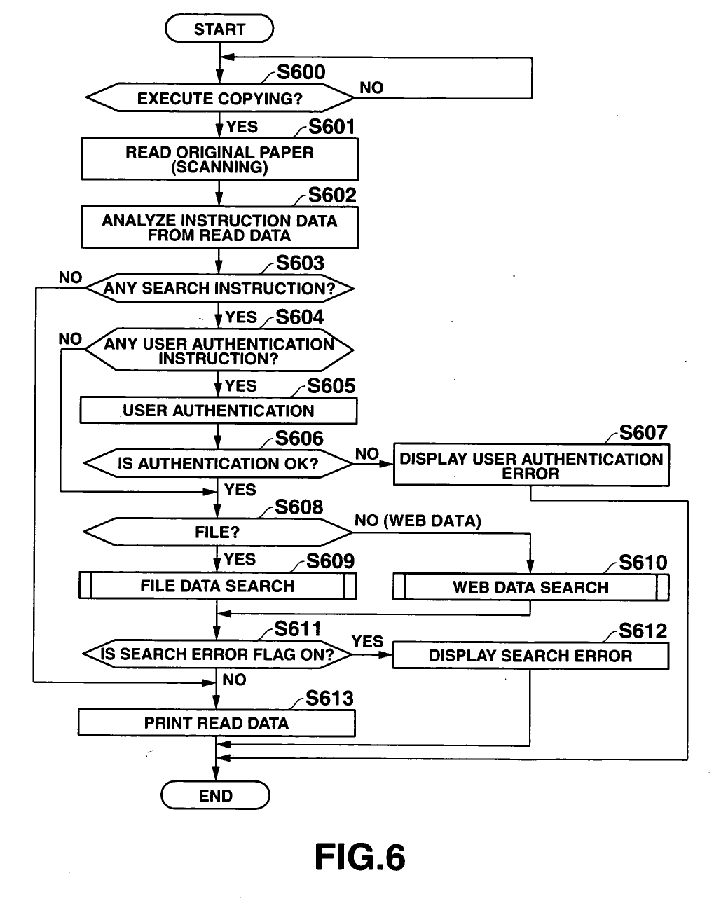

FIG. 6 is a flow chart showing a flow of the image output process to be executed at the copying machine.

In step S600, it is determined whether or not an operator has executed an operation for executing copying (pressing Copy button).

When the operator has done the operation for executing copying, reading of an original paper to be copied is executed in step S601.

In step S602, instruction data (to be recognized with #$DATA: as a reserved word) included in the original paper to be copied is analyzed from the read image data.

In step S603, it is determined as a result of analysis in step S602 whether or not a search instruction is included. Specifically, for example, read image data are recognized by characters, and it is determined whether or not there exists, in the strings whose characters have been recognized, a URL indicating a storage location of an information resource stored in the Internet or a file address indicating a storage location of an information resource stored in a storage medium such as the file server 40, etc. including the copying machine itself.

If it is determined that the search instruction is included (step S603: Yes), it is then determined in step S604 whether or not there is a user authentication instruction. On the other hand, if it is determined that the search instruction is not included (step S603: No), the process proceeds to step S613.

If there is the user authentication instruction (step S604: Yes), general user authentication is executed in step S605 by using an ID or a password for user authentication. If the user is authenticated in step S606 (step S606: Yes), the process goes to S608, while if the user is not authenticated (step S606: No), the image output process ends after displaying a user authentication error in step S607. On the other hand, if there is no user authentication instruction (step S604: No), the process proceeds to step S608.

In step S608, it is determined whether the search instruction that has been determined to be “present”, in step S603, includes instruction data for searching a file such as document data or spread sheet data, or instruction data for searching Web data.

If it is determined in step S608 that the instruction data for searching a file is included (step S608: Yes), a “file data search process” is executed in step S609. If it is determined in step S608 that the instruction data for searching Web data is included (step S608: No), a “Web data search process” is executed in step S610.

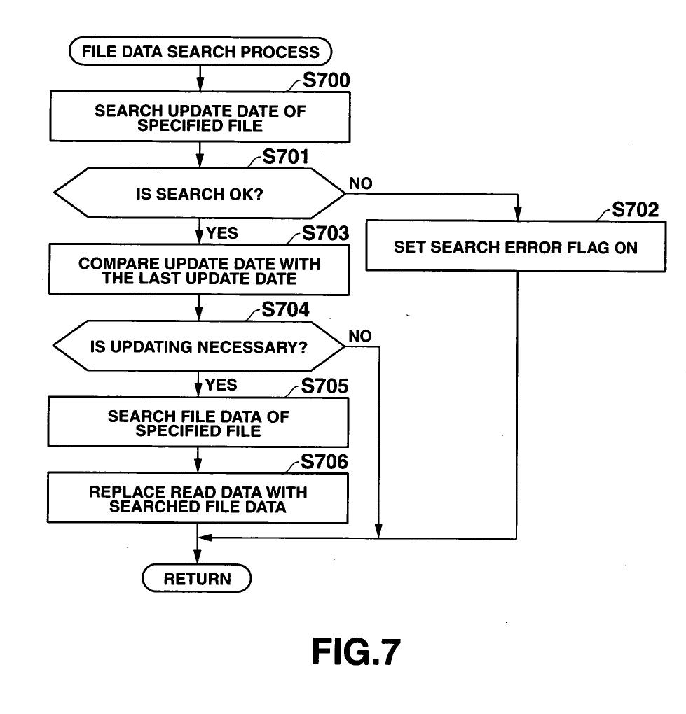

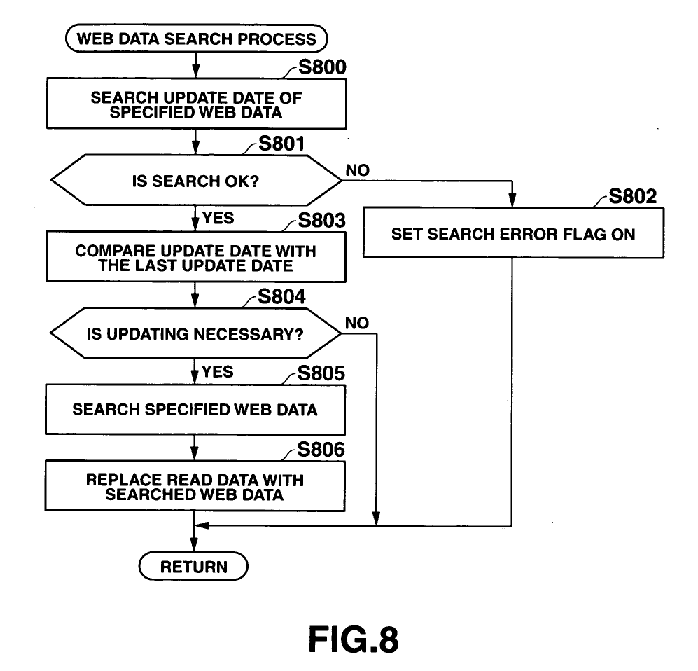

Now, the “file data search process” in step S609 and the “Web data search process” in step S610 will be described in more detail with reference to FIGS. 7 and 8.

FIG. 7 is a flow chart showing a flow of the “file data search process” in step S609.

In step S700, an update date of the file specified by the instruction data included in the search instruction that has been determined to be “present” in step S603 of FIG. 6 is searched.

In step S701, it is determined whether or not the specified file has been searched. If it has not been searched (step S701: No), a search error flag that is reset (is OFF) by default is set (is turned ON) in step S702, search process of the file data terminates, and the process returns to the image output process in FIG. 6. On the other hand, if it has been searched (step S701: Yes), in step S703, the update date of the searched file data is compared with the last update date of the image data of the original paper read in step S601 of FIG. 6.

In step S704, it is determined whether or not updating is needed (i.e., whether the update date of the searched file data differs from the last update date of the image data of the original paper read in step S601 of FIG. 6) as a result of the comparison in step S703.

If it is determined that updating is needed (step S704: Yes), in step S705, the file data of the file specified by the instruction data included in the search instruction that has been determined to be “present” in step S603 of FIG. 6 is searched, and in step S706, the image data read in step S601 of FIG. 6 is replaced with the file data searched in step S705, and the process returns to the image output process of FIG. 6. On the other hand, if it is determined in step S704 that updating is not needed (step S704: No), the search process of the file data terminates and the process returns to the image output process of FIG. 6.

FIG. 8 is a flow chart showing a flow of the “Web data search process”.

In step S800, an update date of Web data specified by a URL by the instruction data included in the search instruction that has been determined to be “present” in step S603 in FIG. 6 is searched.

In step S801, it is determined whether or not the specified Web data has been searched. If it has not been searched (step S801: No), a search error flag that is reset (is OFF) by default is set (is turned ON) in step S802, search process of the file data terminates, and the process returns to the image output process in FIG. 6. On the other hand, if it has been searched (step S801: Yes), in step S803, an update date of the searched Web data is compared with the last update date of the image data of the original paper read in step S601 of FIG. 6.

In step S804, it is determined whether or not updating is needed (i.e., whether the update date of the searched Web data differs from the last update date of the image data of the original paper read in step S601 of FIG. 6) as a result of the comparison in step S803.

If it is determined that updating is needed (step S804: Yes), in step S805, the Web data specified by the instruction data included in the search instruction that has been determined to be “present” in step S603 of FIG. 6 is searched, and in step S806, the image data read in step S601 of FIG. 6 is replaced with the Web data searched in the step S805, and the process returns to the image output process of FIG. 6. On the other hand, if it is determined in step S804 that updating is not needed (step S804: No), the process terminates the search process of the file data and returns to the image output process of FIG. 6.

Returning to the description of FIG. 6, it is determined in step S611 whether or not the search error flag is ON. If it is ON (step S611: Yes), in step S612, a message indicating a search error is displayed and the image output process terminates. On the other hand, if the search error flag is OFF (step S611: No), the process proceeds to step S613.

In step S613, the read image data or the file data replacing the image data is printed and output. In other words, if it is determined in step S603 that there is not search instruction, the read image data is directly printed and output. If it is determined in step S603 that there is the search instruction, and it is further determined in step S608 that the instruction data for searching a file is included, the file data replaying the image data is printed and output. If it is determined in step S603 that there is the search instruction, and it is further determined in step S608 that the instruction data for searching Web data is included, the Web data replaying the image data is printed and output.

When the file data or the Web data replacing the image data is printed and output, the latest update date is output to, for example, the right end of the top of the paper. This will be the last update date next time copying is done.

An example of output of the copying machine will be described.

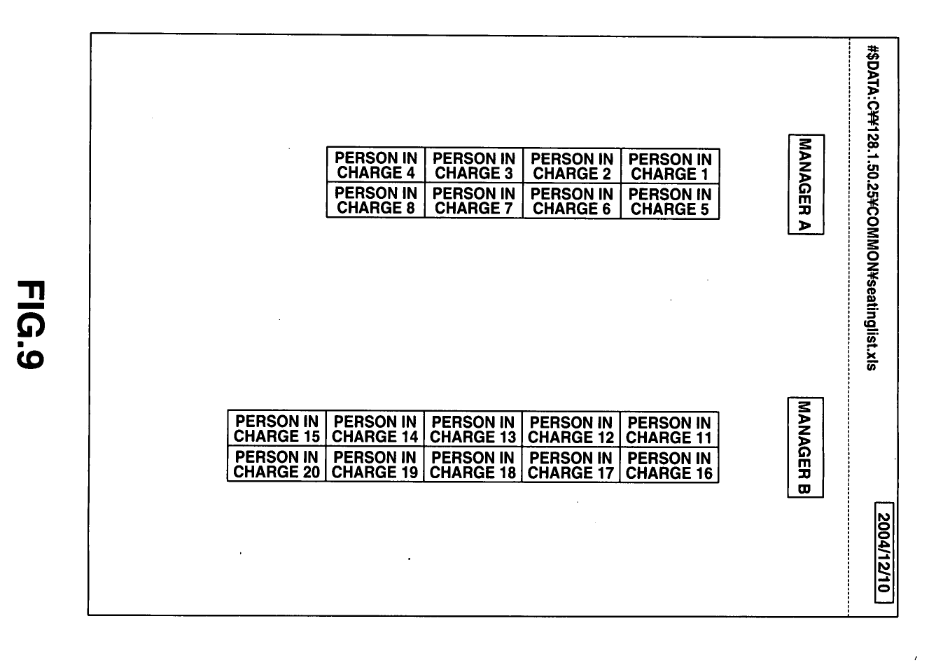

FIG. 9 is a view showing a printout example 1 of file data.

The instruction data included in the read image data is “#$DATA:c¥¥128.1.50.25¥COMMON¥seatinglist.xls”. After user authentication, the copying machine searches, and prints and outputs the file “seatinglist.xls” specified with “¥¥128.1.50.25¥COMMON¥” on the network 20, as it was updated on Dec. 10, 2004.

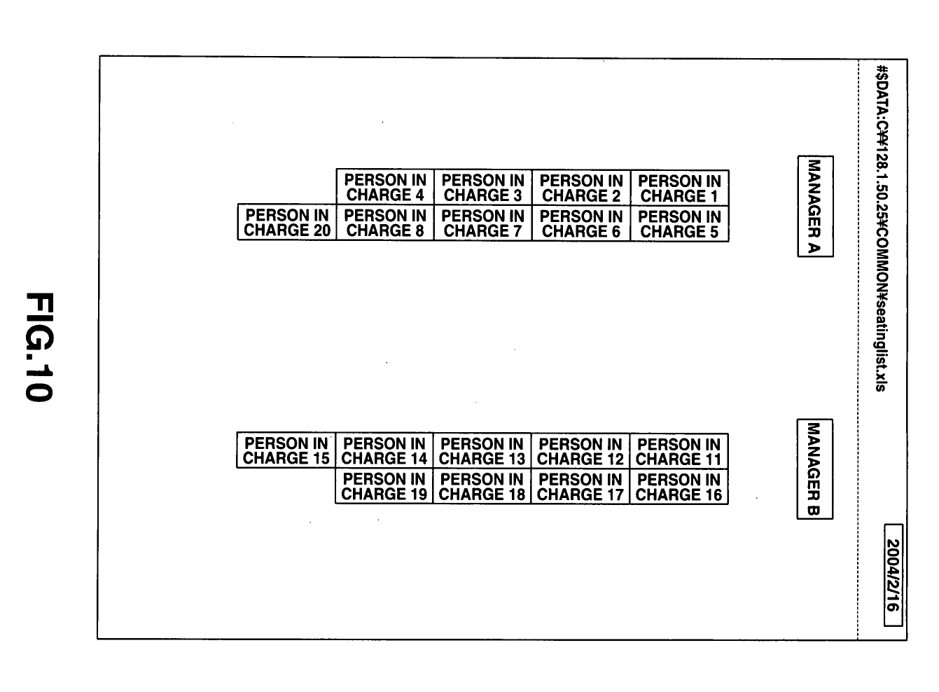

FIG. 10 is a view showing a printout example 2 of file data.

The instruction data included in the read image data is “#$DATA:c¥¥128.1.50.25¥COMMON¥seatinglist.xls”. After user authentication, the copying machine searches, and prints and outputs the file “seatiglist.xls” specified with “¥¥128.1.50.25¥COMMON¥”, on the network 20, as it was updated on Feb. 16, 2005. FIG. 10 shows the latest content after the content of FIG. 9 has been updated.

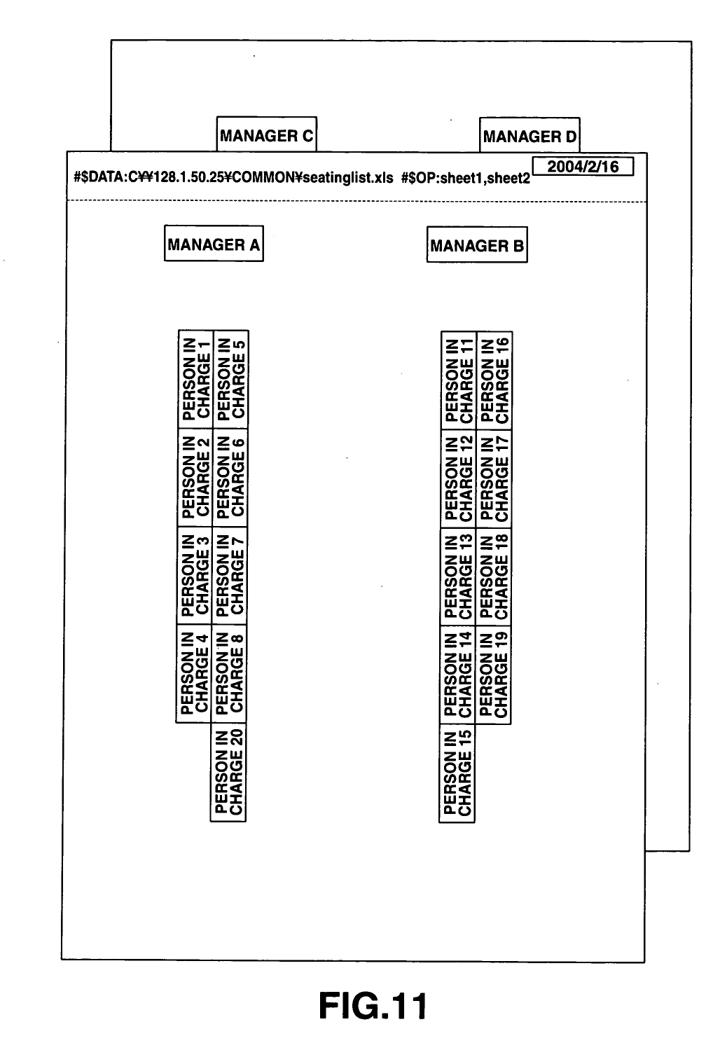

FIG. 11 is a view showing a printout example 3 of file data.

The instruction data included in the read image data is “#$DATA:c¥¥128.1.50.25¥COMMON¥seatinglist.xls #$OP:sheet1,sheet2”. After user authentication, the copying machine searches the file “seatinglist.xls” specified with “¥¥128.1.50.25¥COMMON¥” on the network 20, and prints and outputs sheet 1 file and sheet 2 file specified by “#$OP: (option to be specified)sheet1,sheet2”. In FIG. 11, the first page shows a seating list of Section A and Section B and the second page shows a seating list of Section C and Section D.

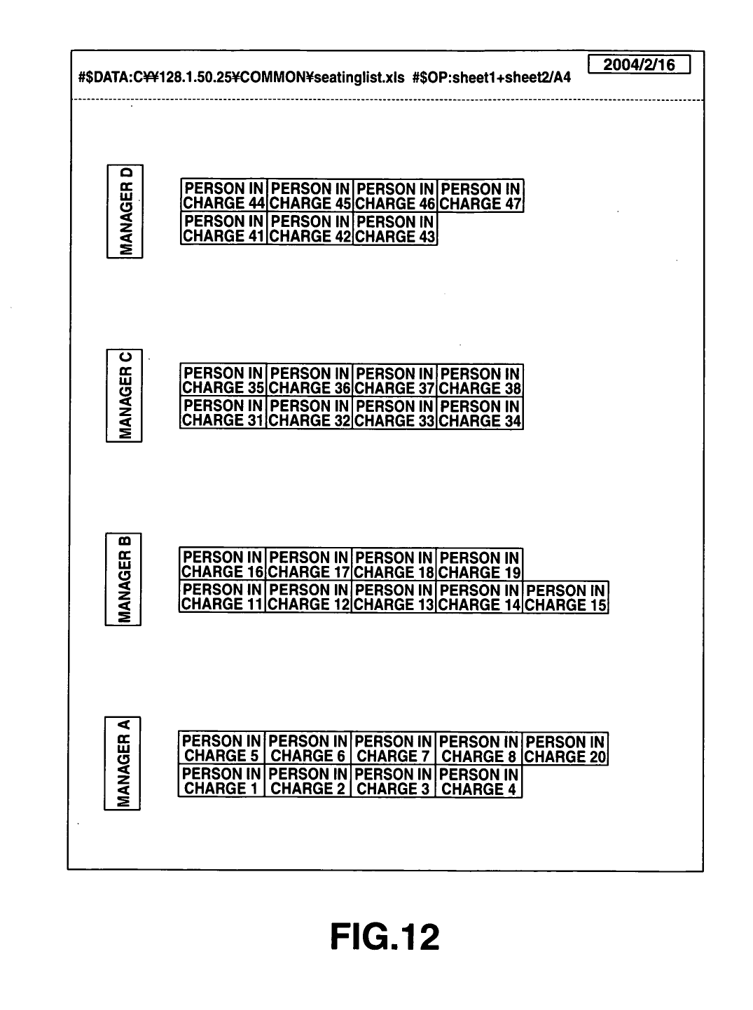

FIG. 12 is a view showing a printout example 4 of file data.

The instruction data included in the read data is “#$DATA:c¥¥128.1.50.25¥COMMON¥seatinglist.xls #$OP:sheet1,shee2/A4”. After user authentication, the copying machine 10 searches the file “seating.xls” specified by “¥¥128.1.50.25¥COMMON¥” on the network 20, and inputs and outputs sheet1 and sheet2 of the file specified by “$OP: (option to be specified)sheet1,sheet2/A4” on the same page of A4 size. In FIG. 12, the left half of the page shows the seating list of Section A and Section B of sheet1, while the right half of the page shows that of Section C and Section D of sheet2.

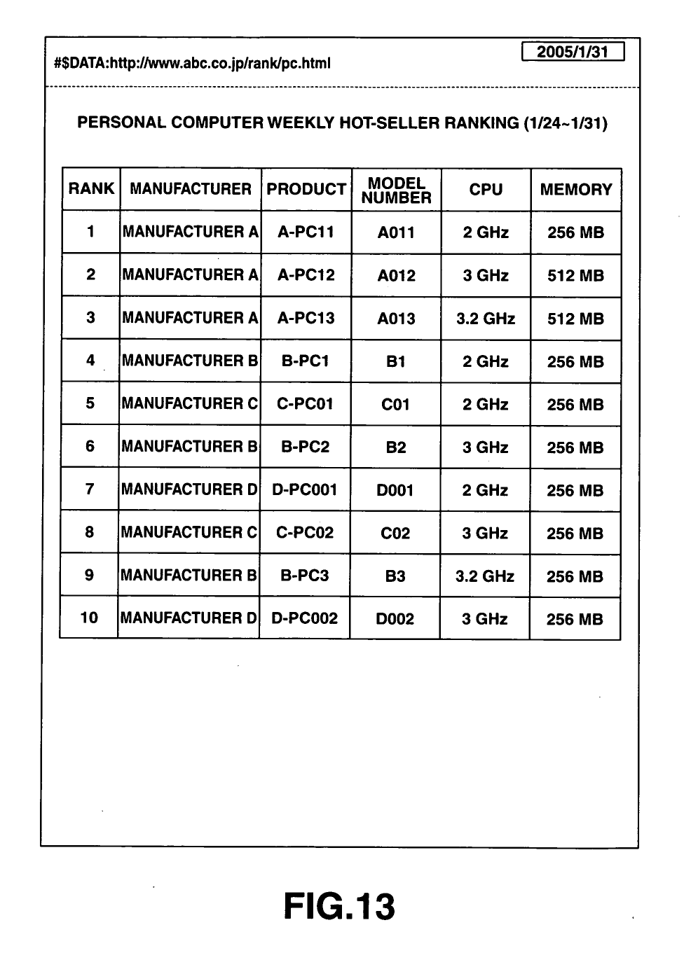

FIG. 13 is a view showing a printout example of Web data.

The instruction data included in the read image data is “#$DATA:http://www.abc.co.jp/rank/pc.html”. After user authentication, the copying machine searches the Web data specified by “http://www.abc.co.jp/rank/pc.html” on the Internet 20 and prints and outputs it.

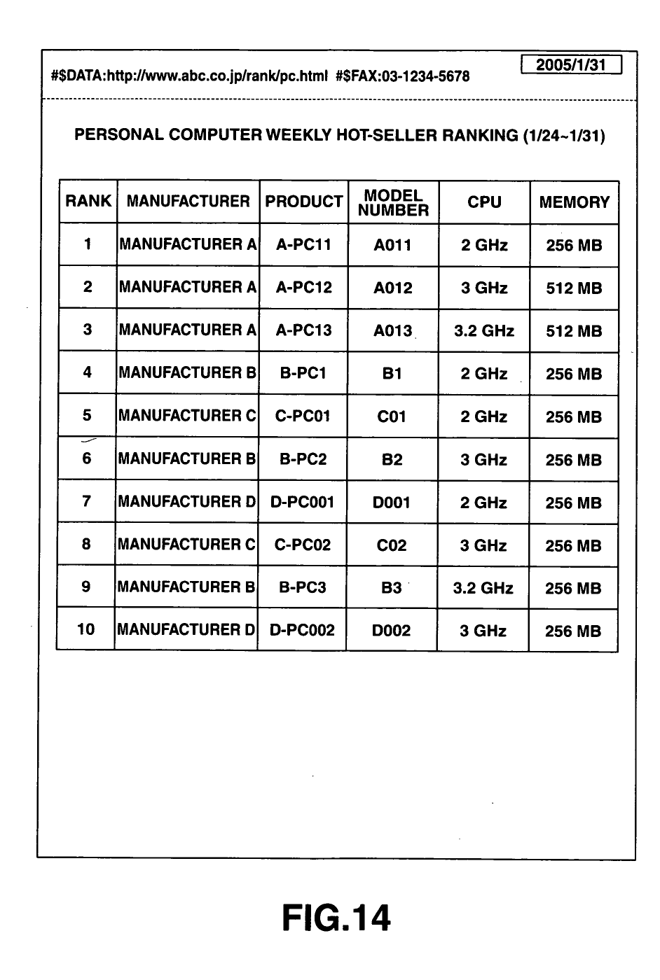

FIG. 14 is a view showing a FAX output example of the Web data.

The instruction data included in the read image data is “#$DATA:http://www.abc.co.jp/rank/pc.html #$FAX:03-1234-5678”. After user authentication, the copying machine searches the Web screen specified by “http://www.abc.co.jp/rank/pc.html” on the Internet 20, and sends it to the FAX destination specified with “#$FAX:03-1234-5678” by facsimile.

The embodiments of the present invention have been described with reference to the drawings. The image output device (copying machine) may perform user authentication at a web site, and determine result of the authentication at the copying machine.

The instruction data may be modified by adding items of data in accordance with necessary functions. In addition, the instruction data may be a two-dimensional code or manually written data.

A setting area of the instruction data is not limited to the top of the original paper, and may be the bottom of the original paper or elsewhere.

A last update date may appear not only on the upper right end of a paper, but also on the bottom of the original paper or elsewhere.

Charging process may be executed for the content searched for depending on search, for every user.

According to an embodiment of the present invention, an image output device comprises:

an image reading unit which reads an image which includes an instruction image;

an instruction data analysis unit which analyzes instruction data included in image data read by the image reading unit;

a search unit which searches an information resource storage unit in which information resources are stored for an information resource specified by the instruction data;

a determination unit which compares the image data read by the image reading unit with a searched information resource searched by the search unit to determine whether or not the read image and the searched information resource are identical; and

an image printing unit which prints the searched information resource when the determination unit determines that the read image and the searched information resource are not identical.

It is desirable that if the determination unit determines that they are identical, the image printing unit prints and outputs the image data read by the image reading unit.

It is also desirable that the instruction data is an URL that indicates a storage location on the Internet where information resource is stored, and that the information resource is Web data.

Further, it is desirable that the instruction data is a file address indicating a storage location where information resource is stored in a storage medium, and that the information resource is file data.

Furthermore, it is desirable that the determination unit determines whether or not date information recorded in a predetermined position of the read image data is same as date information included in the information resource.

Furthermore, it is desirable that the image output device of the embodiment may further comprise an authentication unit for authenticating an operator, and if the authentication unit authenticates that an operator is a predetermined operator, the image printing unit prints and outputs information resource searched by the search unit or image data read by the image reading unit.

It is also desirable that the image output device of the embodiment further comprises a charging unit for charging when the search unit searches for information resources.

It is also desirable that the instruction data is a two-dimensional code.

Further, it is desirable that the instruction data includes format information for identifying an output format when the image printing unit prints and outputs.

It is also desirable that the image output device of the embodiments further comprises a facsimile unit for sending images by facsimile, and that the instruction data also includes an output instruction to the facsimile unit.

According to another embodiment of the present invention, an image output method comprises:

reading an image which includes an instruction image;

analyzing instruction data included in image data read by the reading step;

searching an information resource storage unit in which information resources are stored for an information resource specified by the instruction data;

comparing the image data read by the reading step with a searched information resource searched by the searching step to determine whether or not the read image and the searched information resource are identical; and

printing the searched information resource when the determination step determines that the read image and the searched information resource are not identical.

According to still another embodiment of the present invention, a computer program product is configured to store program instructions for execution on a computer system enabling the computer system to perform:

reading an image which includes an instruction image;

analyzing instruction data included in image data read by the reading step;

searching an information resource storage unit in which information resources are stored for an information resource specified by the instruction data;

comparing the image data read by the reading step with a searched information resource searched by the searching step to determine whether or not the read image and the searched information resource are identical; and

printing the searched information resource when the determination step determines that the read image and the searched information resource are not identical.

According to the embodiments of the invention, if copy source data is simply written on an original paper to be copied in a specific format, copy source data is automatically searched, and the latest data is copied and printed together with the last update date if it is found at the time of copying that the copy source data has been updated. In addition, if the copy source data has not been updated, the copy source data can be directly copied and output, thus enabling the latest data to be printed out at any given time through simple operation.

The copy source data may be data of Web specified by URL, and thus, data on a home page that is varying from hour to hour can be copied and output.

The copy source data may be file data such as Word or Excel specified by a file name, thus enabling the latest data in a file being used at work to be copied and output at any given time.

When the copy source data is searched, user authentication of an operator who copies can be executed, thus enabling security check whereby only an authorized person can copy and output the copy source data.

When the source data is searched, charging can be executed, thus enabling a user who wishes to copy to be charged for the expense of copying.

A paper size or output format for printout can be specified, thus being able to accommodate various output formats.

An entry format of copy source data can use a two-dimensional code, and thus can be rendered unidentifiable by a human when the entry format of the copy source data is not expected to be known to a third party.

Moreover, output by facsimile can substitute for printout, and thus, a printout after searching can be transmitted to a remote location simply by the copying operation.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present invention can be practiced as a computer readable recording medium in which a program for allowing the computer to function as predetermined unit, allowing the computer to realize a predetermined function, or allowing the computer to conduct predetermined unit. The image output device to which the invention is applied is not limited to the embodiments described above, and may be any stand-alone device or a system comprised of more than one device, or an integrated system, or a system that executes processing through a network such as LAN, WAN, etc.

What is claimed is:

1. An image output device comprising:
an image reading unit which reads an image which includes an instruction image;
an instruction data analysis unit which analyzes instruction data included in image data read by the image reading unit;
a search unit which searches an information resource storage unit in which information resources are stored for an information resource specified by the instruction data;
a determination unit which compares the image data read by the image reading unit with a searched information resource searched by the search unit to determine whether or not the read image and the searched information resource are identical; and
an image printing unit which prints the searched information resource when the determination unit determines that the read image and the searched information resource are not identical.

2. The image output device according to claim 1, wherein the image printing unit prints the image data when the determination unit determines that the read image and the searched information resource are identical.

3. The image output device according to claim 1, wherein the instruction data includes a Uniform Resource Locator (URL) that indicates a storage location on the Internet where information resource is stored, and the information resource includes a World Wide Web (WWW) data.

4. The image output device according to claim 1, wherein the instruction data includes an address of a file, and the information resource includes a file data.

5. The image output device according to claim 1, wherein the determination unit determines whether or not date information included in the read image and date information included in the searched information resource are identical.

6. The image output device according to claim 1, further comprising an authentication unit which authenticates an operator, and wherein the image printing unit prints the searched information resource when the authentication unit authenticates the operator.

7. The image output device according to claim 1, further comprising a charge unit which charges a searching of the information resource storage unit by the search unit.

8. The image output device according to claim 1, wherein the instruction data includes a two-dimensional code.

9. The image output device according to claim 1, wherein the instruction data includes format information which identifies an output format of the image printing unit.

10. The image output device according to claim 1, further comprising a facsimile machine for sending the image data, and wherein the instruction data includes an output instruction to the facsimile machine.

11. An image output method comprising:
reading an image which includes an instruction image;
analyzing instruction data included in image data read by the reading step;
searching an information resource storage unit in which information resources are stored for an information resource specified by the instruction data;
comparing the image data read by the reading step with a searched information resource searched by the searching step to determine whether or not the read image and the searched information resource are identical; and
printing the searched information resource when the determination step determines that the read image and the searched information resource are not identical.

12. A computer program product configured to store program instructions for execution on a computer system enabling the computer system to perform:
reading an image which includes an instruction image;
analyzing instruction data included in image data read by the reading step;
searching an information resource storage unit in which information resources are stored for an information resource specified by the instruction data;
comparing the image data read by the reading step with a searched information resource searched by the searching step to determine whether or not the read image and the searched information resource are identical; and
printing the searched information resource when the determination step determines that the read image and the searched information resource are not identical.
